(19) United States
(12) Patent Application Publication
(10) Pub. No.: US 2012/0086208 A1
(43) Pub. Date: Apr. 12, 2012

(54) Environmentally Safe Flowing Water and Air Energy Device With Power Output Optimization

(76) Inventor: Dennis John Gray, Spring, TX (US)

(21) Appl. No.: 12/900,427

(22) Filed: Oct. 7, 2010

(51) Int. Cl. F03B 13/00

(52) U.S. Cl. 290/54

(57) ABSTRACT

This invention is a device for transforming the energy of flowing water or air into useable energy. At a minimum, the device comprises one or more flow diversion structures, one or more paddlewheels, one or more generators and a means by which to control electrical load or otherwise control the rotational speed of one or more paddlewheels which improves the device's power output. A gearbox or transmission may be added to increase the rotational speed of the generators. A cable may be included to transmit the electrical energy from the device to other locations. Other elements may be added as described by the claims within this patent application.

### CROSS-REFERENCES TO MOST RELATED APPLICATIONS

| Patent or Application # | Title |
|---|---|
| 7,094,017 | Vertical Shaft Driving Device for Vertical Wind Mills |
| 7,063,579 | Method and Apparatus for Retrieving Energy From a Flowing Stream |
| 6,759,757 | Method and Apparatus for Converting Tidal Power into Electrical Energy |
| 6,755,607 | Hydro-Energy Converter |
| 6,246,125 | Portable Wind and Hydro Electric Generating System |
| 5,420,463 | Fluid Driven Power System |
| 4,519,742 | Apparatus for Utilizing the Energy Present in Flowing Water |
| 4,239,976 | Floating Electric Generator Using the Driving Energy of Water |
| 4,392,061 | Apparatus for Utilizing the Energy of Wave Swells and Waves |
| 3,746,875 | Electrical Power Plant Driven by Ocean Waves and Tides |
| 7,378,750 | Tidal Flow Hydroelectric Turbine |
| 7,329,961 | Device for Deriving Energy From Moving Fluids |
| 7,242,107 | Water-based Wind-driven Power Generation Using Submerged Platform |
| 7,147,428 | Hydro Turbine |
| 20040195840 | Miniature Hydro Power Generation System |
| 20080101865 | Hydrodynamic Drive Train for Energy Converters That Use Ocean Currents |
| 20080088135 | Electric Power Generating Systems Using Ring Shaped Generators |
| 20080018113 | Wave Power Plant |
| 20070081861 | Wave Generator |
| 20060019553 | Method and Apparatus for Retrieving Energy From a Flowing Stream of Water |

### STATEMENT REGARDING FEDERALLY SPONSORED RESEARCH & DEVELOPMENT

Not Applicable. No others have rights to this patent. Dennis Gray is the sole inventor and the invention was not created under any federally sponsored programs.

### BACKGROUND OF THE INVENTION

Populations grow exponentially, world economies are expanding, demand for energy is escalating, global warming becomes more evident, and fossil fuels are running out. Political tensions regarding hydrocarbons are high to say the least. The United States, and rest of the world, needs solutions to these energy problems and they need them to be clean renewable solutions.

In the Atlantic Ocean off the Southeastern United States runs the Gulf Stream. Essentially, the Gulf Stream is a river of ocean water flowing with an average speed of 4 mph. At its widest point, the Gulf Stream is almost as wide as Florida. This flow of ocean water carries as much energy as the entire world consumes 100 times over, and it flows constantly 24 hrs a day 365 days a year. Similar currents run along the edges of all other continents. This invention can be used in currents, tidal regions, and even rivers.

Numerous companies have designed and built devices that convert the energy of flowing water into useable electricity, but such devices tend to consist of traditional turbines. These marine turbines are very similar to common wind turbines but they are designed to be used underwater. Marine turbines have rotating blades that slice through the water, and likewise slice at whales, manatees, dolphins, and other marine animals that may be swimming by. These blade impacts not only injure marine life but also break the blades of the device and render the marine turbine useless until it is repaired. When traditional marine turbines are used in flowing rivers they are not only susceptible to damage by animal impacts, but by debris such as tree branches that drift downstream. Solutions to these problems are virtually impossible to find because screening the water flow ahead of such turbines ultimately blocks the energy itself. Any screen would soon get clogged with seaweed and marine growth in a very short period of time. A new approach was deemed necessary and the invention herein provides the solutions, offers a more cost-effective solution, and delivers a lower cost/kWh.

Generating massive amounts of renewable energy is different than ship propulsion. Thus, the fact that mankind has moved away from using paddles in ship propulsion does not apply. The cost of a propeller has little impact to the long term cost-effectiveness of a ship's propulsion system. The cost of a “propeller” in a renewable energy device, on the other hand, has an enormous impact on the cost-effectiveness of the device due to its size. We acknowledge that a paddle can be as much as 25% less efficient than a typical turbine blade. Said another way, we recognize that a paddle may extract as little as 75% of the force that a turbine blade of similar area might extract. We fully accept this efficiency reduction, or an even greater efficiency reduction, because a paddle has a significant cost per unit area advantage. In short, massive sail areas on paddles can be created at very low costs vs. thick turbine blades made of expensive materials. Large but inexpensive surface areas are necessary to deliver a cost/kWh that is less solar, biofuels, wind, and even fossil fuel energy. It has been missed in most renewable energy devices, but a means by which to optimally balance torque vs. rpm is also instrumental to delivering lowest cost/kWh.

To be reliable, a device that converts energy from flowing water cannot be complex. Sophisticated components should be avoided and all critical components must be well protected from the harsh wet conditions. An uncomplicated design will also ensure capital, operating, and maintenance costs associated with the device will be very low. When costs are low enough, the resulting cost per kilowatt hour can match that of fossil fuels.

Ideally, a device that converts energy from flowing water should also be capable of being scaled up to enormous size without requiring an array, or vast quantities, of such devices. Many devices in an array only results in hundreds, if not thousands, of components needing to be maintained. Spread out amongst the array, even simple components will be difficult to maintain if they are distributed out over several square miles. An ideal device would still have an extremely low number of components even when scale up and sized to produce hundreds of megawatts. Finally, an ideal device would not be affected by hurricanes nor typhoons that might pass by. The novel invention described herein can deliver on every objective mentioned in the paragraphs above.

Upon review of all similar innovations, one will find that prior art has addressed only a few of the necessary requirements. Without addressing all of them, such a device cannot produce power both safely and cost-effectively. Particular features not found in prior inventions make this particular invention considerably more viable, practical, economical, cost-effective, and harmless to underwater environments. The most novel feature is that means by which to optimally balance torque and rpm is added. When a paddlewheel rotates too quickly it has a higher rpm but torque can drop to almost nothing. It drops to nothing because the paddles are essentially “going with the flow” and they are not fighting or resisting the flow of water that provides the energy. Conversely, torque is maximized when rpm is minimized to almost zero but rpm is too slow to for sufficient power output. Such devices need a means by which to control electrical load or otherwise control the rotational speed of the paddlewheel for greater if not optimized power output.

### BRIEF SUMMARY OF THE INVENTION

The purpose of this invention is to safely, efficiently, and cost effectively transform the energy of moving water into useful electrical energy and do so with virtually no impact to underwater environments. The novelty and effectiveness of this invention is primarily due to several beneficial features herein. First, this invention permits animals such as dolphins, manatees and whales to safely swim directly through the invention unharmed unlike traditional marine current turbines which have blades that slice through the water and impact animals. Secondly, just one of these devices can be scaled up to enormous size without creating an array of these devices. Arrays of devices result in excessive components, high maintenance, and considerably higher costs. This innovation can be scaled so large that it can match the power output of large hydroelectric power plants. Even at enormous size this invention still contains the same low number of components that a scale model of the device contains. Most importantly, a means by which to control electrical load or otherwise control the rotational speed of the paddlewheel is added to this invention to improve if not optimize power output. Paddlewheel rotational speed can be constantly and continuously modified or tuned to maximize the power output of the device.

This invention, due to the remarkably low number of components and the selection of components that perform well under water, can be operated and maintained at extremely low costs. The design of this invention ensures that capital costs are very low and reliability is extremely high. The critical components in this invention are 100% protected from water contact which keeps maintenance costs negligible. Great care has been taken to ensure that installation costs associated with this invention are very low due to the types of components selected and the use of modular construction methods. As a result of the unique features described above, this invention produces energy at extremely low costs, maximizes its power output, and does so with virtually no impact to the environment. Power can be extracted 24 hrs a day 365 days a year even when currents, or water flow, is just 1 knot or less because components within the invention accelerate the flowing water to higher speeds. Since only very low water speeds are required, this invention can be utilized in thousands of locations where flow was previously considered to be too slow.

In essence, the invention consists of at least one or more flow diversion structures, one or more paddlewheels, one or more bearings or bushings about which the paddlewheel spins, a shaft that transmits the rotational energy from the paddlewheel to a generator, and a means by which to control electrical load or otherwise control the rotational speed of the paddlewheel for optimized power output. When desired or cost-effective a transmission or gearbox can be added to increase the rotational speed of the generator. The power can be stored or a subsea cable can delivers the electrical energy from the generator to shore, rig/platform, island, or any other location for power consumption.

### BRIEF DESCRIPTION OF THE SEVERAL VIEWS OF THE DRAWINGS

FIG. 1 is a side view of a preferred embodiment of the invention.

FIG. 2 is an isometric plan view of a preferred embodiment of the invention.

FIG. 3 is a side view of a preferred embodiment showing the back side of the flow diversion structure.

FIG. 4 is an isometric plan view of a preferred embodiment showing the components above water level.

FIG. 5 is a plan view showing two preferred embodiments of the invention as to create a funnel or nozzle.

FIG. 6 is an elevation view showing two preferred embodiments of the invention side by side.

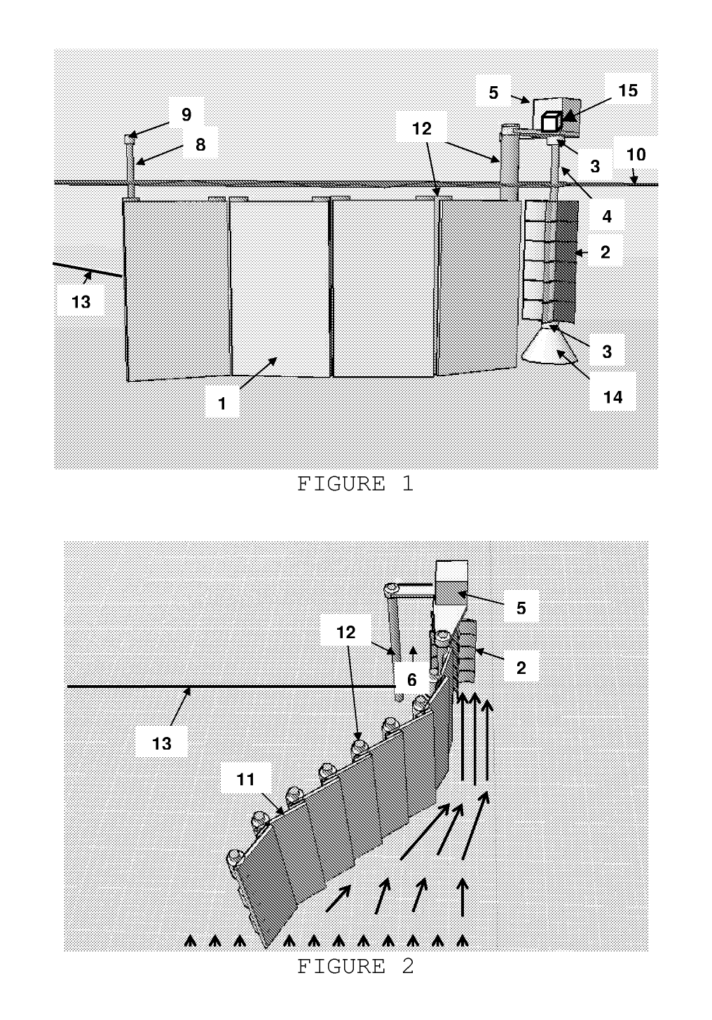

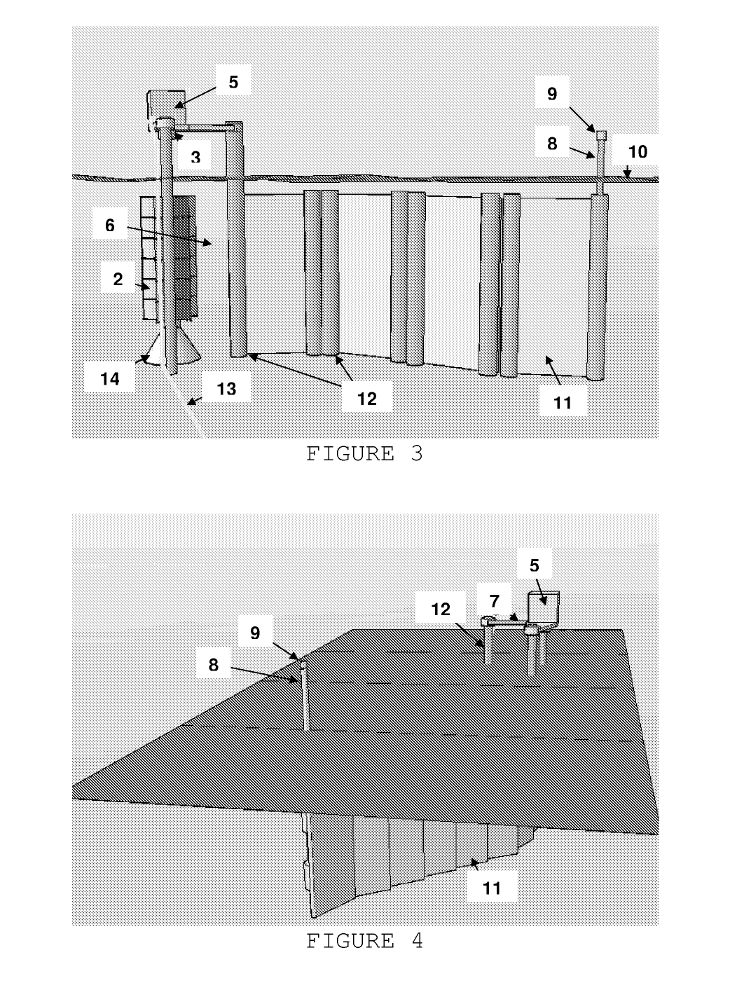

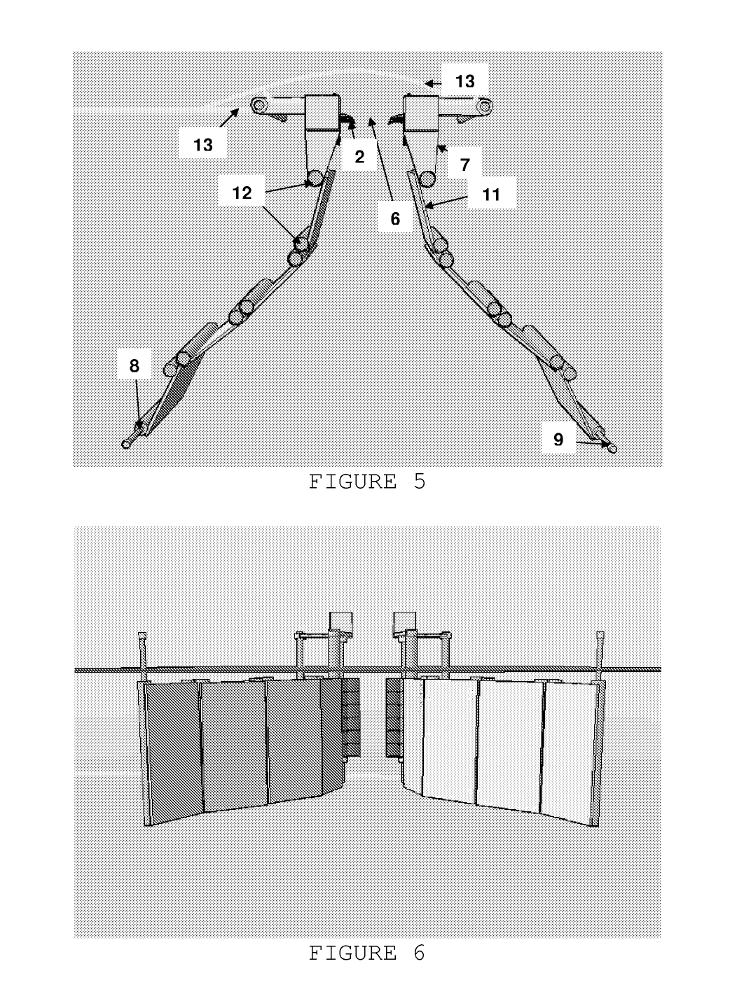

### DESCRIPTION OF THE PREFERRED EMBODIMENT

The invention can be designed and scaled for any water depth, current width, and power output requirement. A preferred embodiment would primarily be constructed of painted steel and other suitable marine grade materials. Components of the device include one or more flow diversion structures (1) installed upstream from a paddlewheel (2) whereby the paddlewheel rotates about bushings and/or bearings (3) when water is flowing near the flow diversion structure. Paddle and flow diversion wall surfaces can consist of large sail areas. When water is flowing near the flow diversion structure the water is accelerated, and this faster moving water causes the paddlewheel to rotate, which in turn rotates a shaft (4), which in turn drives a generator located in the generator (5) in a generator enclosure. In a preferred embodiment, the generator would be a large diameter annular generator so that a gearbox or transmission would not be necessary. However, a transmission can be installed and placed between the paddlewheel shaft and the generator. This optional item increases the speed of the shaft that enters the generator. Most generator types operate more efficiently when spinning at higher speeds and the complete system can be more cost-effective if a gearbox is used.

It is important to note that the flow diversion structure (1) and paddlewheel (2) can be spaced (6) sufficiently far apart from one another to avoid any pinch points for marine animals that may be in the vicinity. This deliberate spacing (6) is best displayed in FIG. 2. The spacing between these components can be large enough to permit even the largest of whales to pass through the spaces. Fish, dolphins, manatees, whales, and other marine life swimming by this invention are likely moving at similar speeds as the flowing water itself and in the same direction as the moving water. Thus, these animals will not likely do more than just brush against a paddle of the paddlewheel. Due to centripetal forces, animals and objects near the paddlewheel are inherently propelled away from the paddles. Nevertheless, the tips/edges of paddles on the paddlewheel, as well as the edges of flow diversion structure, can consist of soft flexible materials to ensure that any contact with marine animals is a soft contact and does not injure the animals. Despite the safety features that result from the above mentioned design features, the paddles are moving slowly to generate more torque which makes them virtually harmless to marine life that comes in contact with them. It is not the speed of the paddlewheel that generates enormous amounts of energy, but the size and power of the water behind the paddles that results in the staggering amounts of energy. In this device, torque is more important than rpm.

The incredible efficiency of this device is not achieved via the use of paddles vs. turbine blades because paddles are known to be less efficient that turbine blades. The incredible efficiency is a result of the large paddle areas that can be created at low cost, the size of the device that can be created in comparison with traditional marine turbines, and the acceleration of water that results from the installation of one or more flow diversion structures. The use of flow diversion structures with traditional marine turbines would funnel marine life directly into the dangerous slicing blades and is therefore not a viable addition. Prior art using paddlewheels were floating systems where the paddlewheels were only partially submerged at water level leaving them highly vulnerable to storms. The novel invention herein utilizes flow diversion structures in combination with paddlewheels which enable the paddlewheels to be highly productive despite being fully submerged under water and therefore safe from storms. Of course, floating systems such as those built from converted ships can be made and sailed away from severe storms.

In this device's typical installations the clearance between water level and most components of the invention ensures that storms such as hurricanes and typhoons do no effect the device, nor the power output of the device. The only components that likely extend above the water surface are the legs of the platform structure (7), the generator room (5) that is mounted on top of the platform structure, and the structural cylinder (8) with navigational beacon light (9) which would likely mark the other end of the device. In a preferred embodiment, lights are installed on all items that extend above the water surface to notify ships of their location at night and in fog. Nevertheless, this invention would most likely be installed far from shipping lanes.

In an alternative embodiment, the generator room (5) can remain at an elevation well below water level (10). In this case there would likely be passage ways for air intake, air outflow, and manway passage to the generator room. In a preferred embodiment, however, the generator room is above mean water level and consists of a windowless steel or concrete room to protect the generator and any other power processing equipment that may be housed inside the generator room from storms. In an alternative embodiment, the three passage ways that extend out of the water would likely be constructed of robust cylinders made from thick steel plate and these cylinders would be trussed together much like the triangular leg of a jack-up oil rig. To clarify, the air intake passage would likely permit air flow into and around the generator for cooling. The air outflow passage would likely permit heated air to exit the generator room (5). Finally, a manway passage would likely permit a person to climb down into the generator room (5) to perform maintenance and repairs as necessary. Despite extending well into the sky to ensure the largest of storm waves would not wash over and into passage ways, all three passages would likely include watertight hatches to provide redundant protection from water intrusion. In an alternative embodiment, flow diversion structures may be installed both horizontally and vertically to accelerate the water in both horizontal and vertical directions.

At five to ten miles out, this invention would not likely be visible from shore. All critical components are enclosed and protected from the harsh wet environment. Bushings or bearings (3) can be fully sealed and the generator is completely enclosed. In a preferred embodiment, the bushings/bearings (3) likely consist of ball bearings or nylatron materials. The flow diversion structure (1) is modular in construction in a preferred embodiment. A flow diversion structure would likely be made up of panels (11) or sails that span between suction piles (12) at each panel end. One at a time, each panel of a flow diversion structure could be installed with its suction piles (12) anchored deep into the seabed. Note that the generator platform structure (7) atop its own piles (12) would likely be installed before the one or more flow diversion structures (1). This sequence is preferred since it avoids higher currents that result at the platform (7) and paddlewheel (2) locations if the flow diversion structure were to be installed first. A subsea cable (13) would be included in the preferred embodiment to bring the electrical power from generator and generator room to shore. A cone shaped structure (14) can be provided at the base of the paddlewheel to properly deflect any objects. An electrical switch (15) or other means by which to control electrical load or control the rotational speed of the paddlewheel is added to improve if not optimize power output. Essentially, this means by which to control the rotational speed of the paddlewheel enables the proper balancing of torque and rpm. As shown in FIG. 6, one or more of these inventions may be installed together. This would improve efficiency by creating a funnel or nozzle to the paddlewheels, but it eliminates the possibility that animals such as whales could swerve very far left or very far right of this device to avoid a paddlewheel altogether.

In a preferred embodiment, the generator room (5) also encloses power processing equipment and transformers to boost power voltage prior to sending it down the subsea cable (13) to shore. The generator room is likely windowless, climate controlled, and de-humidified to create and ideal environment for electrical equipment. A robust windowless construction also ensures it can withstand hurricane storm forces. The platform structure is located far above water level (10) in a preferred embodiment to elevate it above storm surge and highest waves that occur in severe storm conditions. Obviously, this invention can be used to harness the energy of moving air (winds) as well as moving water (currents, tides, and rivers).

In an alternative embodiment, the paddles of the paddlewheel can articulate, bend, pivot, or increase/decrease in size depending upon their location in the circle of motion of the paddlewheel. For example, when paddles are in the location of highest/fastest flow, or more useful flow, the paddles could automatically extend out to better capture this useful flow, yet retract when paddles later move to rotational locations of less useful flow. This would increase paddle productivity when extended, and reduce paddle resistance when retracted. In an alternative embodiment, mechanisms could be installed to automatically articulate the paddles or change their extended lengths during the rotation of a paddlewheel, which in turn would increase the device performance. However, the added complexity and maintenance required in such paddle extension/retraction systems may outweigh the benefits of the improved efficiency provided by them. Paddles can simply pivot about an axis and be backed at their edge by a structural member to create high cross sectional areas with oncoming flow, and pivot away into a flagging position with hardly any cross sectional area in the direction of oncoming flow when flows are not coming from useful directions. These modifications may or may not provide efficiency benefits that outweigh maintenance drawbacks.

What is claimed is:

1. A device for transforming the energy of moving water or air into useable energy comprising one or more flow diversion structures, one or more paddlewheels, one or more shafts, one or more generators which convert the rotational energy transmitted through one or more shafts into useable electricity, and a means by which to control electrical load or otherwise control the rotational speed of one or more paddlewheels which improves the device's power output.

2. The device of claim 1 whereby one or more transmissions or gearboxes are included which results in improved rotational speed of one or more generators.

3. The device of claim 1 whereby one or more paddles of one or more paddlewheels have flexible or soft tips.

4. The device of claim 1 whereby the leading edge or trailing edge of one or more flow diversion structures have flexible or soft tips.

5. The device of claim 1 whereby the width or height of one or more paddles is made adjustable in size resulting in improved energy extraction when the direction of flow relative to one or more paddles is more useful, and resulting in decreased drag when the direction of flow relative to one or more paddles is less useful.

6. The device of claim 1 whereby one or more paddles can pivot, or partially pivot, to create increased cross-sectional area against the direction of flow when the direction of flow relative to one or more paddles is more useful, and pivot, or partially pivot, to create less cross-sectional area against the direction of flow when the direction of flow relative to one or more paddles is less useful.

7. The device of claim 1 whereby one or more cables is included resulting in the transportation of energy from the device to another location.

8. The device of claim 1 whereby warning equipment is included on or near the device which alerts persons to the location of said energy device.

9. A device for transforming the energy of moving water or air into useable energy comprising one or more flow diversion structures, one or more paddlewheels, whereby one or more flow diversion structures and one or more paddlewheels are spaced sufficiently far apart from one another resulting in improved safety for animals, one or more shafts, one or more bushings or bearings to enable one or more paddlewheels to rotate, one or more generators which convert the rotational energy transmitted through one or more shafts into useable electricity, and a means by which to control electrical load or otherwise control the rotational speed of one or more paddlewheels which improves the device's power output.

10. The device of claim 9 whereby one or more transmissions or gearboxes are included which results in improved rotational speed of one or more generators.

11. The device of claim 9 whereby one or more paddles of one or more paddlewheels have flexible or soft tips.

12. The device of claim 9 whereby the leading edge or trailing edge of one or more flow diversion structures have flexible or soft tips.

13. The device of claim 9 whereby the width or height of one or more paddles of one or more paddlewheels is made adjustable in size resulting in improved energy extraction when the direction of flow relative to one or more paddles is more useful, and resulting in decreased drag when the direction of flow relative to one or more paddles is less useful.

14. The device of claim 9 whereby one or more paddles can pivot, or partially pivot, to create increased cross-sectional area against the direction of flow when the direction of flow relative to one or more paddles is more useful, and pivot, or partially pivot, to create less cross-sectional area against the direction of flow when the direction of flow relative to one or more paddles is less useful.

15. The device of claim 9 whereby one or more cables is included resulting in the transportation of energy from the device to another location.

16. The device of claim 9 whereby warning equipment is included on or near the device to alert persons to the location of said energy device.
